(19) United States
(12) Patent Application Publication
(10) Pub. No.: US 2023/0016045 A1
(43) Pub. Date: Jan. 19, 2023

(54) WIDEBAND DUAL POLARIZED HOURGLASS SHAPED WITH WEDGE ANTENNA FOR 3G/4G/5G BASE STATION ANTENNA

(71) Applicant: VIETTEL GROUP, Ha Noi City (VN)

(72) Inventors: Thi Anh Vu, Ha Noi City (VN); Trong Toan Do, Ha Noi City (VN); Dinh Hai Truyen Hoang, Ha Noi City (VN); Duc Nhat Nguyen, Ha Noi City (VN); Minh Thuy Le, Ha Noi City (VN); Van Manh Khong, Vinh Tuong District (VN); Vu Xuan Trung Nguyen, Ha Noi City (VN); Thi Them Truong, Ha Noi City (VN)

(73) Assignee: VIETTEL GROUP, Ha Noi City (VN)

(21) Appl. No.: 17/747,791

(22) Filed: May 18, 2022

(30) Foreign Application Priority Data
Jul. 2, 2021 (VN) 1-2021-04084

(51) Int. Cl. H01Q 21/26; H01Q 1/24; H01Q 9/28

(52) U.S. Cl. CPC H01Q 21/26; H01Q 1/246; H01Q 9/28

(57) ABSTRACT

A wideband dual-polarized hourglass-shaped with wedge antenna for a 3G/4G/5G base station is designed using characteristic mode analysis to adjust resonant frequencies. The proposed antenna has a wide bandwidth when adding two pairs of wedges on the radiator, yielding two linear polarizations ±45°, and fulfilling all the requirements of 3G/4G and 5G antenna elements. The antenna is mechanically designed and easy to fabricate with die-casting, thus saving cost since only a single die is required for mass fabrication with low errors and large quantities.

### FIELD OF THE INVENTION

This invention relates to an hourglass-shaped with wedge magneto-electric dipole antenna. In particular, the operating frequency of the antenna has a wider bandwidth by adding two pairs of wedges. The antenna is mechanically designed and easy to fabricate with die-casting, thus saving cost since only a single die is required for mass fabrication with low errors and large quantities.

### BACKGROUND OF THE INVENTION

The outstanding features of 5G technology (5th Generation—fifth-generation wireless mobile network technology) compared to previous technologies are its superior transmission speed and the rapid response of wireless networks. Not only inheriting outstanding technologies of the previous 4G technology, but 5G technology also applies new technologies such as Massive MIMO (multiple input multiple output) with up to 64 receiver/transmitter ports or beamforming to increase the number of concurrent users; and other technologies to increase link diversity, enhancing message reliability and latency.

To expand bandwidth, 5G technology has been researched and developed at higher frequency bands, including two main bands, the sub-6 GHz frequency band, and the 20 GHz to 60 GHz frequency band called Millimeterwave-mmW. Operating at higher frequencies makes the bandwidth expandable from 100 MHz at 4G up to 400 MHz at the sub-6 GHz band and 2 GHz at the mmW band. In Vietnam, two licensed n41 2.6 GHz and n77 3.7 GHz bands are allowed for 5G. Therefore, the dual-polarization, high isolation, and wideband antenna (covering all frequencies of 3G/4G/5G at sub-6 GHz) are required for base station application. This antenna structure must be suitable for mass production with low error and stable operation and low cost.

There are different configurations of wideband, dual-polarized antennas designed for base stations in recent years, such as patch antennas, electromagnetic dipole antennas, folding electric dipole antennas, and electric cross-dipole antennas. Patch antennas are the most popular as are compact and low cost but have narrow bandwidths. Other antenna structures such as folding electric dipole and cross dipole have a wide bandwidth, good isolation, and XPD (Cross-Polar Discrimination), but their structures are complex and often designed in the form of microstrips, thus the performance will not be stable under the cold and hot weather conditions. Despite noteworthy advantages, these antennas have intricate designs and are often 3-D printed circuit antennas, thus they generally require extra strengthened frames, making them less suitable for industrial mass manufacturing. This problem may be solved by using mechanical antennas since they can operate well in adverse weather conditions, have fewer fabrication errors, and are ideal for mass production because they do not require healing. One of the antenna structures being widely used in the array of base stations is the magneto-electric dipole antenna with characteristics that ensure wideband as well as dual-polarization requirements. Its-dual polarization has a stable radiation pattern over a wide frequency range.

Most magneto-electric dipole antenna structures are microstrip. Although their structures are simple, low weight and easy to manufacture but it is prone to errors during welding and mounting, making them unsuitable for industrial production. Casting technology is currently very popular for antenna fabrication because it is easy to produce in mass, has high mechanical strength, can work well in bad weather conditions, and so on. It is also compatible with microstrip technology, making it a good candidate for element base station antenna. However, mechanical construction has limitations in mold making or design that prevent the antenna from reaching the electric requirements because the impedance matching structures are not too flexible. Therefore, it is necessary to master an analysis method like characteristic mode to understand the radiation part of the antenna so that it can be optimized in the antenna design in a short time.

This invention provides the design of a mechanical dual-polarized magneto-electric dipole antenna, optimally designed for mass production. The proposed antenna structure achieves wide bandwidth, high gain, and high isolation, which can ensure stable multi-band operation at the sub-6 GHz frequency band. In addition, the authors have also proposed the method to add two wedges on each radiator element using the characteristic mode to adjust the operating frequency of the antenna so that the antenna can exhibit optimal performance at a desired frequency. This design can also be easily adjusted to operate at different frequency ranges without having to design a new antenna structure.

### DETAILED DESCRIPTION OF THE INVENTION

The purpose of the invention is to propose a mechanical antenna structure with good isolation, a wide bandwidth that can cover most of the frequency range of 5G technology with a high gain at the operating bands. This antenna gives an economic benefit, and flexibility in hardware deployment for telecommunication infrastructure. The antenna is mechanically and easy to fabricate with die-casting, thus saving cost since only a single die is required for mass fabrication with little error and easy assembly in the industry where a large quantity is required.

To achieve the above purposes, the antenna consists of two magneto-electric dipoles placed orthogonal to each other to create ±45 degree of the dual-polarization, the main antenna structure includes:
The radiation part consists of two magneto-electric dipoles placed orthogonal to each other to create ±45 degree dual polarization, in which: the electric dipole is designed in the shape of an hourglass with two wedges which adjust operating frequencies and increase antenna efficiency. The size of the electric dipole includes the length L_{d}, the angle θ, and the distance between the two holes through the contact section of the hourglass electric dipole D_{f}, the magnetic dipole is designed with a 45-degree bi-fold structure to form a solid cylindrical structure; added piles to ensure that the antenna is not deformed when it is impacted by an external force; the height Hₘ of the dipole affects the resonant frequency of the antenna.
The feeding balun consists of two basic Γ-shaped jumps with dimensions of L_{fx} being the length of the contact part, W_{fx} being the width of the feeding balun, and L_{fx1} being the length of the feeding balun offset inductance (with x=1.2 corresponds to the excited ports for the first and second antennas) with a frequency-dependent length dimension.
The button mechanism part (including 8 pcs) is made by plastic rivets to fix the grounding part on the antenna.

The antenna uses two pairs of Γ-shaped feeds to simultaneously excite two magneto-electric dipoles placed orthogonal to each other, creating ±45 degree linear polarizations. The electric dipole is designed using the characteristic mode analysis, the antenna achieves a wide bandwidth, high peak gain, low back lobe, and side lobe level, which can easily be tuned to suitable frequency for sub-6 GHz bands of all the operators in Vietnam.

### DESCRIPTION OF THE FIGURES

FIG. 1a shows the general structure of the proposed antenna in the invention;

FIG. 1b shows the integral structure of the proposed antenna in the invention;

FIG. 2 shows the basic structure of a magneto-electric dipole antenna;

FIG. 3 shows the radiator structure of the proposed antenna in the invention;

FIG. 4 shows effect of the opening angle θ to the bandwidth (as a percentage of the center frequency) in the frequency range from 1000 MHz to 6000 MHz;

FIG. 5a shows the radiator part horizontal projection of the proposed antenna in the invention;

FIG. 5b shows the radiator part vertical projection of the proposed antenna in the invention;

FIG. 5c shows the feeding structure of the proposed antenna in the invention;

FIG. 6 shows the relationship of the MS value with the resonant frequency of the proposed antenna;

FIG. 7-la-c shows the surface current density simulation results of each mode (a) current J₁, (b) current J₂, (c) current J₃;

FIG. 7-2a-c shows the simulated radiation patterns results of each mode (a) current mode J₁, (b) current mode J₂, (c) current mode J₃;

FIG. 7-3 show the details of the wedge to adjust the resonant frequency and increase the efficiency of the proposed antenna in the invention;

FIG. 8 shows the effect of wedge width to the resonant frequency of the proposed antenna;

FIG. 9 shows the simulated reflection coefficient results of the proposed antenna (without the wedges) at the first and the second port;

FIG. 10 shows the simulated MS parameters results of in the proposed antenna's characteristic mode;

FIG. 11a shows the influence of the wedge width to the reflection coefficient of the proposed antenna;

FIG. 11b shows the maximum gain of the proposed antenna at the first and the second ports with and without the wedges.

FIG. 12 shows the radiation pattern of the proposed antenna at 2.6 GHz at the first port;

FIG. 13 shows the radiation pattern of the proposed antenna at 2.6 GHz at the second port;

FIG. 14 shows the radiation pattern of the proposed antenna at 3.7 GHz at the first port;

FIG. 15 shows the radiation pattern of the proposed antenna at 3.7 GHz at the second port.

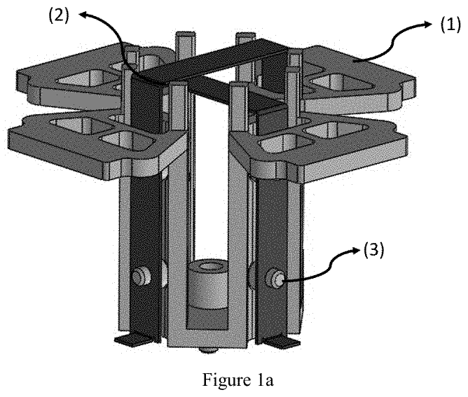

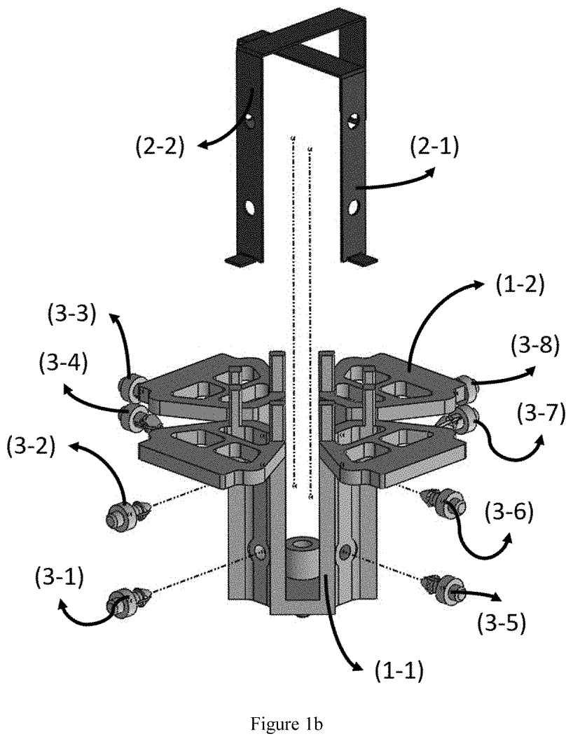

Details of the invention The structure of the proposed 3G/4G/5G radio base station antenna in the invention is shown in FIG. 1a. It consists of three components: radiator part (1), feeding structure (2) and rivets mechanism (3) to fix the feeding structure (2) with the antenna.

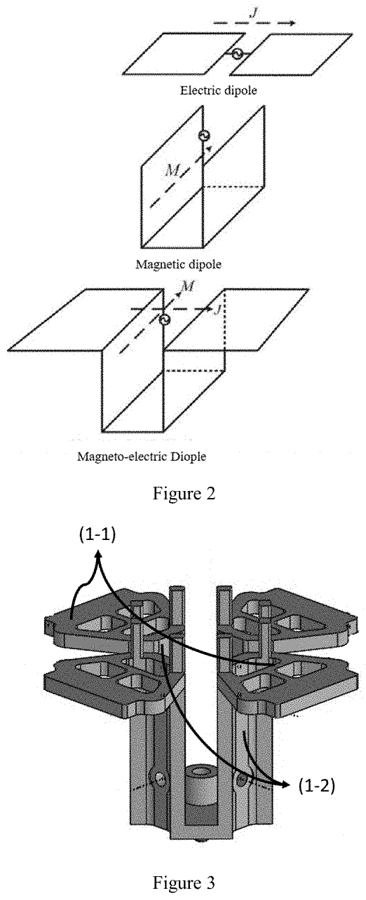

In general, the proposed antenna is developed from a basic magneto-electric dipole antenna (FIG. 2). Radiator element (1) is made by ALDC12.1 or ALSi10Mg silver-plated aluminum material, including a (1-2) magnetic dipole (FIG. 3) and a (1-1) electric dipole (FIG. 3); where: electric dipole (1-1) is designed into an hourglass-shape to obtain a wideband. It is analyzed by the characteristic mode so that the desired resonant frequency can be adjusted to obtain desired operating frequency and to increase the radiation efficiency of the antenna. This is a new point in this invention. In addition, the holes are also cut in the (1-1) electric dipole to reduce the overall weight of the antenna without affecting the antenna performance. Two walls of the magnetic dipole (1-2) are bent 45 degrees to create a solid cylindrical structure that is solid and not easy to deform. Two more protruding piles above each metal plate of the magnetic dipole are inserted to ensure that the antenna is not deformed when it is impacted by an external force, such as the mechanical shell of the base station. These two magneto-electric dipoles are placed orthogonal to each other to create a dual-polarization ±45 degree and are fed by a basic Γ-shaped feed (2). The button mechanism (3) is made by plastic rivets to fix the feeding part (2) on the antenna wall (details from 3-1 to 3-8 in FIG. 1b). The detailed calculation for the proposed antenna is as follows:
Calculate the radiator (1) including the size of the magnetic dipole (1-2) and the size of the electric dipole (1-1).
Magnetic dipole (1-2) consists of two vertical metal walls combined with horizontal metal. The electric field generated between two vertical metal plates and the horizontal metal forms a closed loop, generating a magnetic field. The height of the magnetic dipole Hₘ affects the resonant frequency of the antenna. The size of the magnetic dipole (1-2) (Hₘ) of a magneto-electric dipole antenna with two resonant frequencies is calculated by the following equation:

$${H}_{m} = \frac{32 \times ( 0 , 1 {λ}_{1} + 0 , 15 {λ}_{2} )}{{λ}_{1} - {λ}_{2}} \qquad ( 1 )$$

where λ₁ is the wavelength corresponding with the lower operating frequency f₁ and λ₂ is the wavelength corresponding with the higher operating frequency f₂; the wavelength value of the frequency fᵣ is calculated by equation (2) where c is the speed of propagation of electromagnetic waves in the air:

$${λ}_{0} = \frac{c}{{f}_{r}} \qquad ( 2 )$$

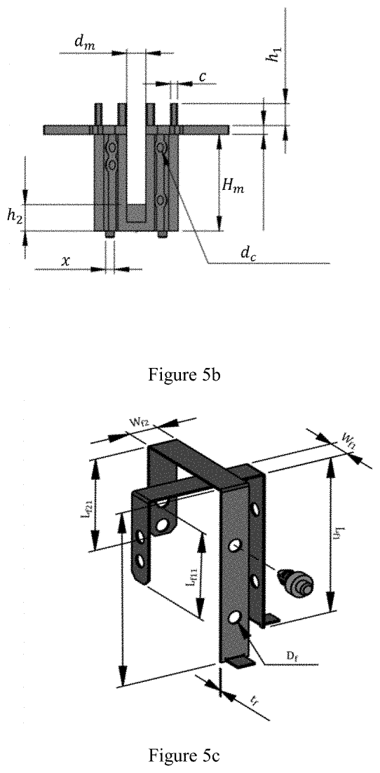

The electric dipole (1-1) is designed in an hourglass shape to obtain a wideband. The resonant frequency of the conventional electric dipole depends on its length (that corresponds with the wavelength at the operating frequency), while the hourglass shape electric dipole does not only depends on the length but also depends on the angle θ. Therefore, it can resonate at different frequencies corresponding with the values of length and opening angle. The dimensions of the electric dipole (1-1) include the length of the dipole L_{d} and the angle θ (FIG. 5a). In which, the value of length L_{d} depends on the operating frequency of the antenna and the distance between the two holes through the contact section in the feeding section of the hourglass electric dipole D_{f}

$${L}_{d} = \frac{- 0 , 091 {λ}_{1}^{2} + 0 , 2055 {λ}_{2}^{2}}{{D}_{f}} \qquad ( 3 )$$

where, D_{f} is calculated by

$$\frac{{λ}_{1} {λ}_{2}}{2 \times c} \times 1 {0}^{9} .$$

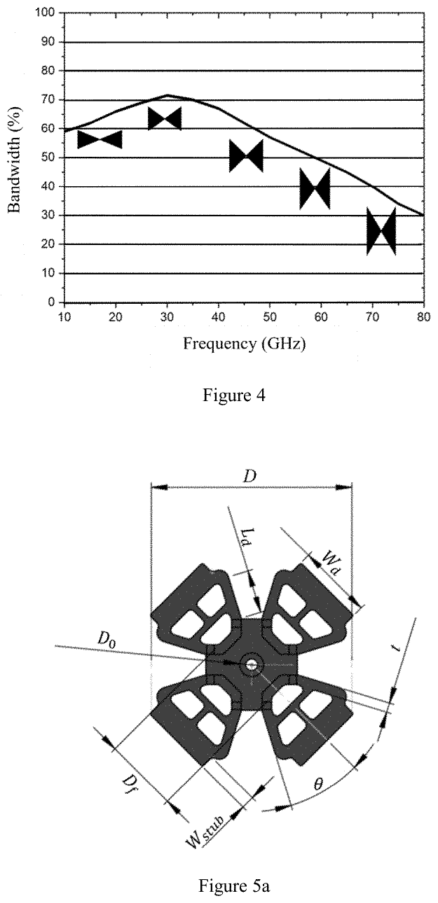

Meanwhile, the angle value θ is directly related to the bandwidth of the antenna. FIG. 4 describes the influence of the opening angle value θ on the bandwidth of the antenna in the frequency range 1000 MHz-6000 MHz. In the frequency range 1000 MHz-6000 MHz, the electric hourglass dipole antenna has a wider bandwidth of 15% compared to the traditional electric dipole. The suitable value θ is chosen to obtain the maximum bandwidth while ensuring that the size is not too big for the array's design purpose.
The feeding (2) using the Γ-shape balun feeding structure is made from ALDC12.1 or ALSi10Mg silver plated thin aluminum plate, consisting of the (2-1) and (2-2) feeding in FIG. 1b. This is the basic structure using to feed the magneto-electric dipole antenna. The length of the Γ₁ feeding for the first antenna includes L_{f1}+D_{f}+L_{f11} and is calculated by

$$\frac{1}{3 , 65} ( {λ}_{1} + {λ}_{2} ) .$$

The length of the δ₂ feeding for the second antenna includes L_{f2}+D_{f}+L_{f21} and is calculated by

$$\frac{1}{3 , 4} ( {λ}_{1} + {λ}_{2} ) .$$

The difference of the length between the two feeding sections ensures the isolation between the two antennas. Where:
L_{f1} is the length of the feeding for the first antenna;
L_{f2} is the length of the feeding for the second antenna;
L_{f11} is the length of the inductance offset for the first antenna;
L_{f12} is the length of the inductance offset for the second antenna;

After calculation and simulation, the antenna will be analyzed using characteristic mode analysis to improve antenna performance as well as to adjust the resonant frequency if the resonant frequency does not match the design requirement. This is the new point of the antenna design in this invention. The characteristic mode analysis helps the designer to deeply understand the radiation characteristics and current distribution on the surface of the structure, then the designers propose a suitable adjustment to improve antenna quality such as the resonant frequency, expanding the bandwidth, increasing the quality factor of the antenna and proposing the new antenna structures.

The characteristic mode analysis method describes the radiation structures according to each characteristic mode instead of calculating and simulating the Full-wave method as traditional. The equation describes the properties of the structure is shown in the following equation:

X(Jₙ)=λₙR(Jₙ) (4)

where:

R (Jₙ) is the resistance matrix of the structure with the current mode Jₙ,

X(Jₙ) is the reactance matrix of the structure with the currents mode Jₙ,

Jₙ is the current mode representing for the surface of the conductor, dependent on its shape and size, and independent on the excitation source.

The value λₙ indicates the resonance level of each mode. The larger the magnitude of λₙ is, the more power is stored in the mode. The sign of λₙ indicates the mode-related the power storage pattern. The mode is inductive when λₙ is positive, and the mode is capacitive when λₙ is negative. The resonance mode on the structure is at that frequency when λₙ=0 then. In a simple way, λₙ expresses the resonant level of a mode through Modal Signaling (MS) as following equation:

$$MS = \vert \frac{1}{1 + j {λ}_{n}} \vert \qquad ( 5 )$$

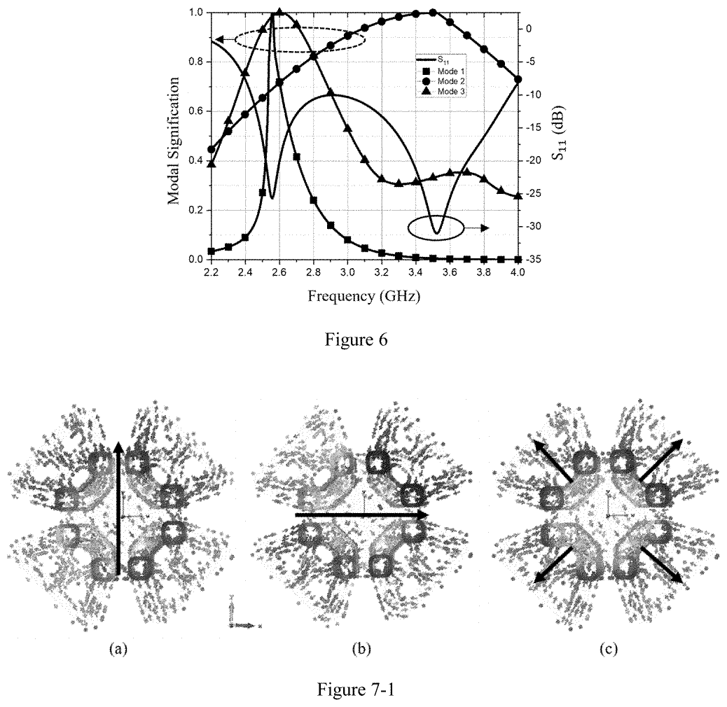

The MS parameter also indicates the radiation level of the mode. When MS=1, it implies that the mode is in resonant state and radiates with maximum efficiency (for example, the MS parameter in FIG. 6 of the proposed antenna structure).

A radiator structure is analyzed to a linear of a finite number of characteristic modal currents, each one excites its own characteristic mode, independent with other currents. Therefore, this property can be applied to analyze the structure according to the properties of each mode and the excitation of the mode of interest, allowing adjust the desired frequency. This is the idea that the authors developed the antenna structure in the invention.

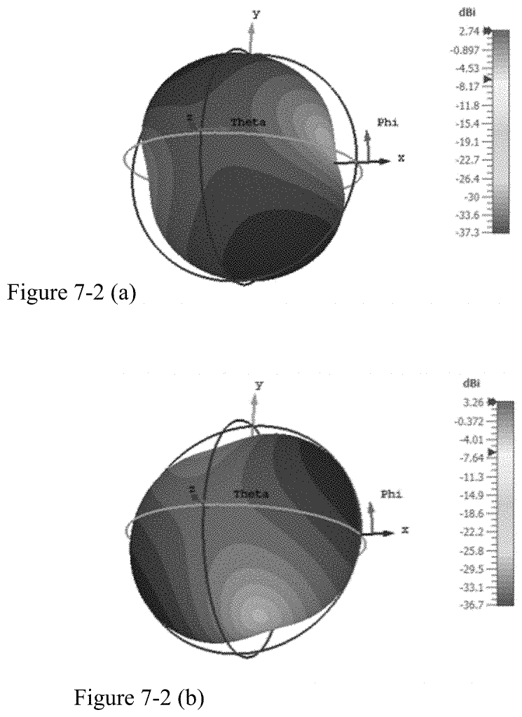

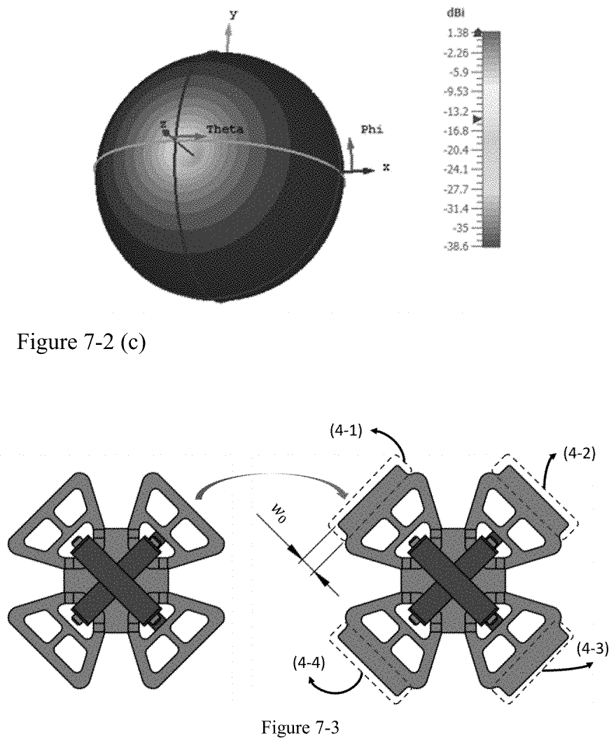

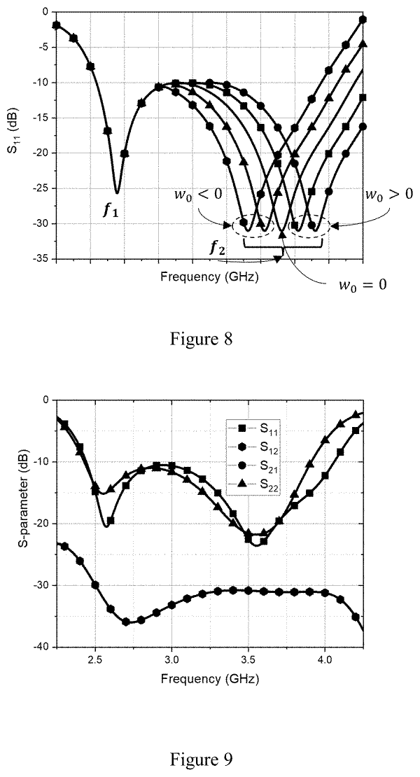

The authors have studied and calculated the resonant frequencies f₁ and f₂ using the characteristic mode, which includes three resonance modes. In which, the first and the second mode determinate the resonant frequency f₁ and the third mode affect the resonant frequency f₂ as shown in FIG. 6. To give more insight into the radiation characteristic of each mode, we investigate their corresponding surface currents density distribution (FIG. 7-1) and the radiation patterns (FIG. 7-2). The modal currents J₁ and J₂ travel in similar ways around from one side of the structure to the other, but in different directions. J₁ polarizes in the y-direction and J₂ polarizes in the x-direction. Moreover, J₁ and J₂ have the same MS value (FIG. 6); hence, they are a pair of degenerate modes. Meanwhile, the modal current J₃ is symmetrical, concentrating mainly on the electric hourglass-shaped dipole center instead of the electric hourglass-shaped dipole sides like J₁ and J₂. The patterns of J₁ and J₂ are similar but with orthogonal directions. The pattern of J₃ is omnidirectional due to the outward flow of its current. From these distributions, we added four wedges with the width of w₀ (4-1, 4-2, 4-3, and 4-4 in FIG. 7-3) at the outmost of the two electric hourglass-shaped dipoles, which affect the current J₃ but not J₁ and J₂ because they barely reach these positions. Thus, the resonant frequency f₂ of the third mode J₃ is independently adjusted to the desired frequency while keeping J₁ and J₂ stable. How the width w₀ of these four wedges affects resonant frequencies is illustrated through S11 in FIG. 8.

As seen from FIG. 8, the second resonance frequency f₂ is shifted up or down depending on the dimension of w₀. This is very useful for the antenna designer since it allows the designer to spend less time of the study the different antennas for different desired frequencies using the same this antenna structure. In addition, operating the closely resonant frequency allows the antenna to radiate more efficiently and minimizes the shifted resonant frequency after manufacturing.

### Example of Implementation Invention

The authors conducted an implemented a wideband antenna for the 64T64R base station application that can work well at two frequency bands: n41: 2.496 GHz-2.69 GHz (center frequency is 2.6 GHz) and n77: 3.6 GHz-3.8 GHz (center frequency is 3.7 GHz) according to the international 3GPP standard. In which, the main frequency bands at 2.6 GHz and 3.7 GHz frequencies are considered in the design, it is licensed for 5G purpose in Vietnam.

The main required specification of an antenna element for a 5G base station are listed in Table 1:

TABLE 1
Specifications of single antenna element for 5G base stations

| No | Requirement | Description | Value | Units |
|---|---|---|---|---|
| 1 | Frequency band | Frequency band n77-FR1 | 2496-2690; | MHz |
| | | and n41 FR-1 for 5G | 3600-3800 | |
| | | (according to 3GPP) | | |
| 2 | Bandwidth | Required antenna | 200 | MHz |
| | | bandwidth | | |
| 3 | Number of port | Number of antenna | 2 | |
| | per an element | in an element | | |
| 4 | Polarization | Dual polarization | +/−45 | Degree |
| 5 | Peak gain | Maximum peak gain of | ≥7 | dBi |
| | | an element | | |
| | | (over all tilt) | | |
| 6 | Reflection | Reflection coefficient | ≤−10 | dB |
| | coefficient | at the input port | | |
| 7 | Isolation | Isolation between two | ≥20 | dB |
| | | port in an element | | |
| 8 | Front to | The extent of backward | ≥12 | dB |
| | back ratio | radiation | | |
| 9 | Cross Polar | The ratio of the co- | ≥15 | dB |
| | Discrimination | polar component of the | | |
| | | specified polarization | | |
| | | compared to the | | |
| | | orthogonal cross-polar | | |
| | | component | | |

From the requirement above, the authors have designed a mechanical magneto-electric hourglass-shaped antenna with four wedges, this antenna has ±45 degree linearly polarization and the peak gain more than 7 dBi.

The detail of designed antenna with all parameters as presented as follows:
The radiator part of the proposed antenna consists of two magneto-electric hourglass-shaped antenna placed perpendicular to each other (FIG. 3), where the electric dipole is designed according to the hourglass shape, the magnetic dipole is bent 45 degrees to both sides to create a solid cylindrical structure which is stable and has 8 vertical pillars to ensure that the antenna is not deformed when it is impacted by an external force above. The material of the radiator part is Silver-plated Aluminum ALDC12.1 or ALSi10Mg. The electric dipole is also perforated to reduce the overall weight of the structure without affecting the antenna performance.
The feeding part (FIG. 5c) consists of two Γ-shaped feedings and is made by silver-plated aluminum ALDC12.1 or ALSi10Mg with the dimensions shown in the following Table 3.
The rivets (consist of 8 pcs, from 3-1 to 3-8 in FIG. 1b) to fix the feeding part with the radiator part.

The parameters of the proposed antenna is described in the following Table 2 and Table 3, where λ₁ and λ₂ is wavelengths at 2.6 GHz and 3.7 GHz:

TABLE 2
Calculated-equations of the main antenna parameters

| | Calculation | Value | |
|---|---|---|---|
| Variable | equation | (mm) | Note |
| Hₘ | $\frac{32 \times ( 0.1 {λ}_{1} + 0.15 {λ}_{2} )}{{λ}_{1} - {λ}_{2}}$ | 22.11 | Height of the magnetic dipole |
| D_{f} | $\frac{{λ}_{1} {λ}_{2}}{2 \times c} \times 1 {0}^{9}$ | 15.5 | Distance between two holes through the contact section |
| | | | of the hourglass- |
| | | | shaped electric dipole |
| L_{d} | $\frac{- 0.0 \; 91 {{λ}_{1}}^{2} + 0. 20 \; 55 {{λ}_{2}}^{2}}{{D}_{f}}$ | 9 | Length of the hourglass-shaped electric dipole |

TABLE 3
The parameters of the proposed antenna

| No. | Variable | Value | Unit | Description |
|---|---|---|---|---|
| 1 | D | 41.95 | mm | Width of the proposed antenna |
| 2 | D₀ | 5 | mm | Screw hole diameter of the antenna |
| 3 | h₂ | 6 | mm | Screw hole height of the antenna |
| 4 | θ | 30 | mm | Opening angle θ of the hourglass- |
| | | | | shaped electric dipole |
| 5 | T | 2 | mm | Thickness of the hourglass-shaped |
| | | | | electric dipole |
| 6 | dₘ | 4.36 | mm | Distance between the perpendicular |
| | | | | of two magnetic dipoles |
| 7 | c | 1.58 | mm | The pile width of the magnetic dipole |
| 8 | h₁ | 5 | mm | The pile height of the magnetic dipole |
| 9 | t_{d} | 2 | mm | Thickness of the hourglass-shaped |
| | | | | electric dipole |
| 10 | d_{c} | 1 | mm | Diameter of screw hole for connection |
| | | | | between feeding and antenna |
| 11 | x | 2 | mm | Diameter of round stake to fix |
| | | | | antenna when installation |
| 12 | L_{f1} | 25.4 | mm | Feeding length for the first antenna |
| 13 | L_{f2} | 28.4 | mm | Feeding length for the second antenna |
| 14 | L_{f11} | 12.9 | mm | Inductance offset length for the |
| | | | | first antenna |
| 15 | L_{f12} | 13.9 | mm | Inductance offset length for the |
| | | | | second antenna |
| 16 | W_{f1} | 4.5 | mm | Width of feeding for the first antenna |
| 17 | W_{f1} | 4.2 | mm | Width of feeding for the second |
| | | | | antenna |
| 18 | t_{f} | 0.3 | mm | Thickness of the feeding |

The results of the proposed antenna are shown in FIG. 9: S-parameter results of the proposed antenna where S₁₁ and S₂₂ are the reflection coefficients at port 1 and port 2, respectively). The reflection coefficients at the input ports S₁₁ and S₂₂ in FIG. 9 show that the reflection coefficient is under −10 dB in the interested frequency bands. However, the resonant frequencies of the antenna are 2.6 GHz and 3.4 GHz. The reason for this is that the feeding component is constructed from a basic Γ-shape structure but its bandwidth is narrow and influences impact the bandwidth of the antenna. Therefore, it is required to adjust the radiator part of the antenna to shift the resonant frequency at 3.4 GHz to nearly 3.7 GHz while remains constant the resonant frequency 2.6 GHz to obtain high efficiency in the interest frequency bands.

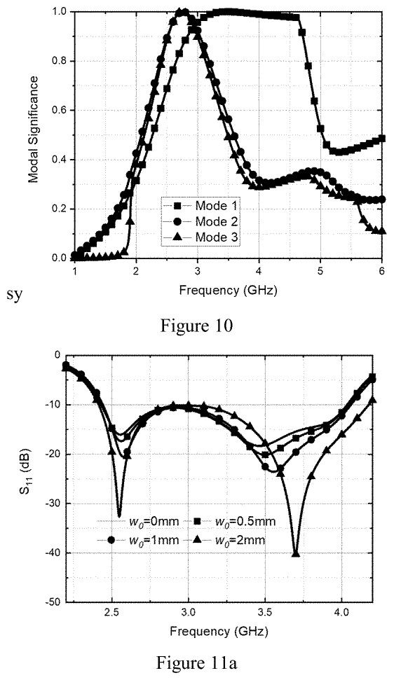

Characteristic mode analysis is used to analyze the antenna structure as the authors are presented. Simulation results of MS values of the structure are shown in FIG. 10. As can be seen that in the frequency range from 2 GHz to 4.5 GHz, there are three modes with MS values reaching 1. As the authors have analyzed and mentioned above and are shown in FIG. 7-1, we have found that J₁ and J₂ are almost identical, at the frequencies of 2.5974 GHz and 2.614 GHz, respectively. J₃ mode has an MS equal to 1 at 3.446 GHz and a value of approximately 1 spanning the frequency range of 3.4 GHz-3.52 GHz. The proposed antenna structure does not meet the design criteria at the frequency range of 3.6-3.8 GHz, so we adjust the structure by turning the width of wedges to control the MS value of J₃ to 1 at the frequency range of interest 3.6 GHz-3.8 GHz.

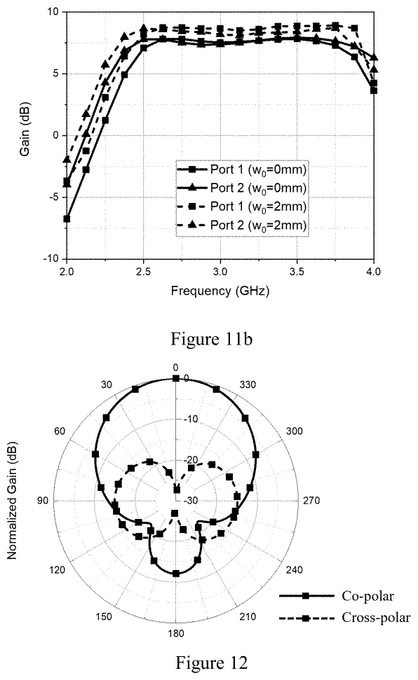

As shown in FIG. 11a, by inserting these wedges with a width of w₀=2 mm, the resonant frequency of the antenna is changed and is represented through the reflection coefficient at the first port. We can see that the second resonant peak caused by the J₃ mode approaches the frequency of 3.7 GHz without having a significant impact on the first resonant frequency at 2.6 GHz, which is determined by the J₁ and J₂ modes. The resonant frequency at 2.6 GHz is unchanged; that means the resonant frequency of the antenna structure has been tuned to the desired frequency. The maximum peak gain of the proposed antenna at both the first and second ports at both frequencies 2.6 GHz and 3.7 GHz are increased around 1.3-1.5 dBi, as in FIG. 11b. It means the antenna radiates more efficiently at these two frequencies, and the resonant frequencies are 2.6 GHz and 3.7 GHz as required. The resonant at desired frequencies is very important to avoid frequency shifting after fabrication.

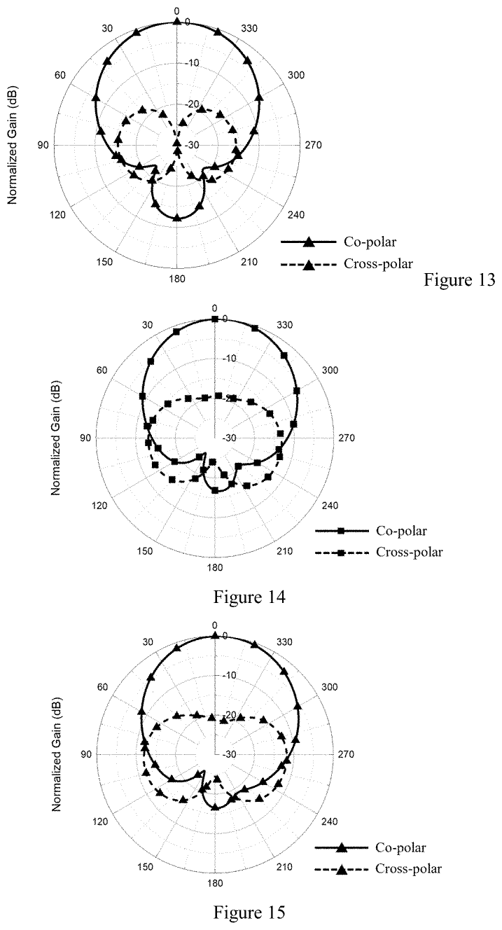

The adding wedges using the characteristic mode analysis changes the resonant frequency from 2.46 GHz to 3.7 GHz and improves the radiating efficiency. The proposed antenna with a bandwidth from 2.42 GHz to 4.2 GHz covers most of the sub-6 GHz frequency bands for 5G technology. Table 4 and FIGS. 12, 13, 14, 15 present the results of the implementing antenna in the invention.

TABLE 4
Summary table of the obtained results of the proposed antenna

| No. | Parameter | Description | Results | | Unit |
|---|---|---|---|---|---|
| 1 | Frequency | Frequency band n41-FR1 | 2496-2690 | 3600-3800 | MHz |
| | band | and n77-FR1 for 5G | | | |
| | | (according to 3GPP) | | | |
| 2 | Bandwidth | Required antenna | 1400 MHz | | MHz |
| | | bandwidth | | | |
| 3 | Number of | Number of antenna | 2 | 2 | |
| | input port | in an element | | | |
| 4 | Polarization | Dual polarization | ±45 | ±45 | degree |
| 5 | Peak gain | Maximum peak gain of | ≥8.3 | ≥8.6 | dBi |
| | | an element (over all tilt) | | | |
| 6 | Reflection | Reflection coefficient | ≤−15 | ≤−22 | dB |
| | coefficient | at the input port | | | |
| 7 | Isolation | Isolation between two | ≥27 | ≥27 | dB |
| | | port in an element | | | |
| 8 | Front to back | The extent of | ≥12 | ≥16 | dB |
| | ratio | backward radiation | | | |
| 9 | Cross Polar | The ratio of the co-polar | ≥20 | ≥19 | dB |
| | Discrimination | component of the specified | | | |
| | | polarization compared | | | |
| | | to the orthogonal | | | |
| | | cross-polar component | | | |

This invention presents a wideband dual-polarized hourglass-shaped with wedges antenna for 3G/4G/5G base station. This magneto-electric antenna element consists of two wideband hourglass-shaped electric dipoles combined with a bent magnetic dipole to obtain ±45-degree dual-polarization. The balun feeding is designed using a basic Γ-shape structure. A highlight of the antenna structure is adding four wedges at the outmost of the two electric hourglass-shaped electric dipoles to adjusts the resonant frequency and therefore improve antenna efficiency at the frequency bands of interest. The antenna element has a stable radiation pattern and a peak gain of 8.3±0.3 dBi over the entire frequency range. The fully mechanical antenna is easy to fabricate with die-casting and is suitable for mass production with low installation cost and errors, requiring low correction cost.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. The wideband dual polarized hourglass-shaped with wedge antenna for 3G/4G/5G base station based on magneto-electric antenna comprising: a radiator part with wedge, a feeding part, and rivets to fix the feeding part with the radiator part,
The radiator part consists of an hourglass-shaped with a wedge electric dipole and a magnetic dipole:
The magnetic dipole consists of two vertical metal walls combined with a horizontal metal, an electric field generated between two vertical metal plates and the metal below forms a closed loop, generating a magnetic field, the magnetic dipole is designed to bend 45 degrees on the two wings to create a solid cylindrical structure that is difficult to be deformed, two more protruding piles above each metal plate of the magnetic dipole is inserted to ensure that the antenna is not deformed when it is impacted by an external force, such as the mechanical shell of a base station, or a transceiver station, the height of the magnetic dipole Hₘ affects the resonant frequency of the antenna, the size of the magnetic dipole 1-2 (Hₘ) of a magneto-electric dipole antenna has two resonant frequencies and it is by following equation:
$${H}_{m} = \frac{32 \times ( 0 , 1 {λ}_{1} + 0 , 15 {λ}_{2} )}{{λ}_{1} - {λ}_{2}} \qquad ( 1 )$$
where λ₁ is the wavelength at a lower operating frequency f₁ and λ₂ is the wavelength at a higher operating frequency f₂; the wavelength value of the frequency fᵣ is calculated by equation (2) where c is the speed of propagation of electromagnetic waves in the air:
$${λ}_{0} = \frac{c}{{f}_{r}} \qquad ( 2 )$$
The electric dipole is designed in an hourglass shape to obtain a wideband, It is designed using characteristic mode analysis to improve antenna performance as well as to adjust the resonant frequency if the resonant frequency does not match the design requirement, wherein the resonant frequency depends on its length and also depends on the opening angle θ, whereby it can resonate at different frequencies corresponding with the values of the length and opening angle, the length of the dipole L_{d} and the angle θ, where the value of length L_{d} depends on the operating frequency of the antenna and the distance between the two holes through the contact section in the feeding section of the hourglass electric dipole D_{f}.
$${L}_{d} = \frac{- 0 , 091 {λ}_{1}^{2} + 0 , 2055 {λ}_{2}^{2}}{{D}_{f}} \qquad ( 3 )$$
where, D_{f} is calculated by
$$\frac{{λ}_{1} {λ}_{2}}{2 \times c} \times {10}^{9} meanwhile ,$$
the opening angle value θ is directly related to the bandwidth of the antenna;
Two magneto-electric dipoles are placed orthogonal to each other to create ±45 degree of the dual polarization and is fed by the Γ-shape balun feeding structure,
The Γ-shape balun feeding structure is made from ALDC12.1 or ALSi10Mg silver plated thin aluminum plate, consisting of the 2-1 and 2-2 feeding lines, the length of the θ₁ feeding for the first antenna includes L_{f1}+D_{f}+L_{f11} and is calculated by
$$\frac{1}{3 , 65} ( {λ}_{1} + {λ}_{2} ) ,$$
the length of the Γ₂ feeding for the second antenna includes L_{f2}+D_{f}+L_{f21} and is calculated by
$$\frac{1}{3 , 4} ( {λ}_{1} + {λ}_{2} ) ,$$
The difference of the length between the two feeding sections ensures the isolation between the two antennas, where:
L_{f1} is the length of the feeding for the first antenna;
L_{f2} is the length of the feeding for the second antenna;
L_{f11} is the length of the inductance offset for the first antenna;
L_{f12} is the length of the inductance offset for the second antenna;
The button mechanism part is made by plastic rivets to fix the feeding part with the antenna wall.

2. The wideband dual-polarized hourglass-shaped with wedge antenna for 3G/4G/5G base station based on the magneto electric antenna can adjust the second resonant frequency f₂ and not affect the first resonant frequency f₁ by adding four wedges using characteristic mode analysis, In detail, the frequency f₂ can be controlled by adding four wedges with lengths equal to the width of the hourglass-shaped electric dipole antenna and tuning the variable width w₀ of four wedges, As a result, the antenna can be tuned over a wide frequency range from 1000 MHz to 6000 MHz, and the gain of the proposed antenna increases at the desired frequency bands.
